(19) United States
(12) Patent Application Publication
(10) Pub. No.: US 2026/0364554 A1
(43) Pub. Date: Nov. 19, 2026

(54) PARTICLE PROCESSING METHOD AND PROCESSING APPARATUS

(71) Applicant: Toyo Engineering Corporation, Chiba-shi, Chiba (JP)

(72) Inventors: Keiji SANO, Chiba-shi, Chiba (JP); Takuhiro MINATO, Chiba-shi, Chiba (JP)

(21) Appl. No.: 18/995,334

(22) PCT Filed: Aug. 18, 2023
(86) PCT No.: PCT/JP2023/029778

§ 371 Date: Feb. 4, 2026

(30) Foreign Application Priority Data
Aug. 23, 2022 (JP) 2022-132207

(51) Int. Cl. B01J 2/16; B01J 2/00

(52) U.S. Cl. CPC B01J 2/16; B01J 2/003

(57) ABSTRACT

Provided are a particle processing method and processing apparatus, wherein heated seed particles are supplied to a granulating step to improve uniformity of a temperature within a granulating device, allowing stable granulation into particles that are uniformly dried to a desired level and have a desired particle size. A particle processing method includes a seed particle conditioning step of supplying a preheating gas to seed particles from below to form a fluidized bed of the seed particles and preheat the seed particles in the fluidized bed, and a granulating step of supplying the heated seed particles via a line and coating a surface of the seed particles with a coating substance under a high-temperature atmosphere to carry out granulation, and a particle processing apparatus with a seed particle conditioning device and a granulating device or a seed particle conditioning and granulating device for performing these steps.

### FIELD OF THE INVENTION

The present invention relates to particle processing method and processing apparatus allowing stable granulation into particles that are uniformly dried to a desired level and have a desired particle size.

### BACKGROUND OF THE INVENTION

Production of a granular product (for example, a chemical product, a medicine or food) requires processing of a solid substance into particles of a desired particle size. Known as a processing method suitable for mass production of a granular product is, for example, a method for enlarging seed particles (small particles formed of the above solid substance) by a granulating device of a fluidized-bed type or a fluidized-bed/spouted-bed type to obtain particles of a desired particle size. Specifically, a gas is supplied to the seed particles from below to form a fluidized bed (or a fluidized bed and a spouted bed) of the seed particles, and a solution containing a coating substance (the above solid substance) is sprayed to the seed particles in this bed, thereby allowing the solution in a liquid droplet form to be adhered and concurrently dried. As a result, a surface of the seed particles is coated with the coating substance in the solution, such that particles of a larger size than the seed particles are obtained.

JP-B H4-63729 describes a process for processing granules by a granule processing apparatus using a fluidizing bed/spouting bed system. FIG. 1 thereof describes a state in which a gas for a fluidizing-bed (the gas for forming the fluidized bed) is uniformly fed from a bottom floor 6 of a perforated plate to form a fluidizing-bed space 7 (the fluidized bed) of granules being processed, and concurrently, a gas (the gas for forming the spouted bed) is spouted from a feed pipe 12 and a solution containing a coating material is sprayed from a nozzle 13 to form a space 8 where the granules being processed are floated into and then fall down (the spouted bed). Further, this coating material in a liquid droplet form sprayed from the nozzle 13 is adhered to a surface of the granules being processed (the seed particles) to obtain enlarged granules.

Particles obtained by a granulating device of a fluidized-bed type or a fluidized-bed/spouted-bed type have a wide particle size distribution in usual. Therefore, it is necessary to classify these particles into product size particles (particles having a target particle size), large particles above the product size and small particles below the product size. The product size particles are then collected. On the other hand, the large particles are crushed into a smaller size, and these are supplied to the granulating device and recycled as the seed particles. The small particles are supplied as-is to the granulating device and recycled as the seed particles.

### SUMMARY OF THE INVENTION

In the method explained above, it is desirable that a temperature of the seed particles be maintained at such an appropriate temperature that can promote drying. Therefore, in a conventional general method, for example, the gas for forming the fluidized bed (or the gas for forming the fluidized bed and the gas for forming the spouted bed) is heated, so that a zone in which granulation is performed by coating is maintained, by this gas, in an atmosphere having a temperature higher than ambient temperature.

On the other hand, a temperature of the particles recycled as the seed particles after undergoing each step such as the classifying step or the like is decreased as heat is dissipated in each of such steps. Therefore, a temperature of the seed particles supplied to the granulating device is usually lower than a temperature within the granulating device.

Further, the seed particles supplied to the granulating device are sometimes exposed to ambient air and absorb moisture before being supplied, so that a moisture content thereof is increased. Further, a temperature thereof may also vary due to a difference in temperatures among seasons or a difference in temperatures between day and night.

As explained above, a temperature and a moisture content of the seed particles supplied to the granulating device are changed by various causes. Further, the present inventors paid attention to the respect that a partial decrease in a temperature within the granulating device (particularly, near a seed particle supply inlet) caused by supplying seed particles having a low temperature or a high moisture content to the granulating device results in insufficient or non-uniform drying, leading to lower product quality, and they thought that this needed to be improved.

In other words, the present invention is aimed at providing particle processing method and processing apparatus allowing stable granulation into particles that are uniformly dried to a desired level and have a desired particle size.

### Means to Solve the Problem

As a result of diligent study to achieve the above goal, the present inventors found it very effective to add a seed particle conditioning step utilizing a preheating gas and a fluidized bed prior to a granulating step to preheat seed particles in this seed particle conditioning step, leading to the completion of the present invention.

The present invention is a particle processing method including:
a seed particle conditioning step (sc) of supplying a preheating gas to seed particles from below to form a fluidized bed of the seed particles and preheat the seed particles in the fluidized bed; and
a granulating step (gr) of coating a surface of the seed particles heated in the seed particle conditioning step (sc) with a coating substance under a high-temperature atmosphere to carry out granulation.

Further, the present invention is a particle processing apparatus including:
a seed particle conditioning device (SC) for supplying a preheating gas to seed particles from below to form a fluidized bed of the seed particles and preheat the seed particles in the fluidized bed; and
a granulating device (GR) for coating a surface of the seed particles heated by the seed particle conditioning device (SC) with a coating substance under a high-temperature atmosphere to carry out granulation.

Further, the present invention is a particle processing apparatus with a seed particle conditioning and granulating device (SC/GR) including:
a seed particle conditioning zone (SCZ) in which a preheating gas is supplied to seed particles from below to form a fluidized bed of the seed particles and preheat the seed particles in the fluidized bed; and
a granulating zone (GRZ) in which a surface of the seed particles heated in the seed particle conditioning zone (SCZ) is coated with a coating substance under a high-temperature atmosphere to carry out granulation.

Further, the present invention is a method for improving an existing particle processing apparatus with a granulating device (GR) for coating a surface of seed particles with a coating substance under a high-temperature atmosphere to carry out granulation, characterized by:
adding, to the existing particle processing apparatus, a seed particle conditioning device (SC) for supplying a preheating gas to seed particles from below to form a fluidized bed of the seed particles and preheat the seed particles in the fluidized bed, such that the seed particles after heating by the seed particle conditioning device (SC) are coated with the coating substance under the high-temperature atmosphere to carry out granulation in the granulating device (GR); or
replacing the granulating device (GR) with a seed particle conditioning and granulating device (SC/GR) including a seed particle conditioning zone (SCZ) in which a preheating gas is supplied to seed particles from below to form a fluidized bed of the seed particles and preheat the seed particles in the fluidized bed and a granulating zone (GRZ) in which a surface of the seed particles heated in the seed particle conditioning zone (SCZ) is coated with a coating substance under a high-temperature atmosphere to carry out granulation, such that the seed particles after heating in the seed particle conditioning zone (SCZ) are coated with the coating substance under the high-temperature atmosphere to carry out granulation in the granulating zone (GRZ).

The particle processing method of the present invention is characterized by including the seed particle conditioning step (sc). In this seed particle conditioning step (sc), the seed particles are preheated by the preheating gas. Therefore, a temperature of the seed particles is increased. If granulation is performed by using these seed particles, deterioration in uniformity of a temperature within the granulating device (GR), particularly, near a seed particle supply inlet, and uniformity of drying can be suppressed.

Further, in this seed particle conditioning step (sc), the preheating gas is supplied to form the fluidized bed of the seed particles. As a result, the seed particles in the fluidized bed are heated by this preheating gas. Such a heating method utilizing the fluidized bed is excellent in terms of uniformity of a temperature of the seed particles compared to other heating methods. Therefore, deterioration in uniformity of a temperature within the granulating device (GR) and uniformity of drying can be suppressed more efficiently.

As explained above, the particle processing method of the present invention can suppress deterioration in uniformity of a temperature within the granulating device (GR) and uniformity of drying as it includes the seed particle conditioning step (sc). Therefore, the present invention allows stable granulation into particles that are uniformly dried to a desired level and have a desired particle size.

### BRIEF DESCRIPTION OF DRAWINGS

FIG. 1 is a process flow diagram illustrating an embodiment of the method and apparatus of the present invention.

FIG. 2 is a process flow diagram illustrating another embodiment of the method and apparatus of the present invention.

### EMBODIMENTS OF THE INVENTION

### Granulating Step (GR)

In the present invention, a granulating step (gr) is a step of coating a surface of seed particles heated in a seed particle conditioning step (sc) with a coating substance under a high-temperature atmosphere to carry out granulation. Further, a granulating device (GR) is a device for coating a surface of seed particles heated by a seed particle conditioning device (SC) with a coating substance under a high-temperature atmosphere to carry out granulation.

A granulating method in the granulating step (gr) is not particularly limited, and may be any method for coating the surface of the seed particles with the coating substance under the high-temperature atmosphere. For example, a method for spraying a coating solution containing the coating substance to the seed particles to coat the surface of the seed particles with the coating substance can be used. With this method, the solution in a liquid droplet form is adhered to the surface of the seed particles and dried, allowing granulation into particles larger than the seed particles.

As such a granulating method, a granulating method of a fluidized-bed type for forming a fluidized bed to perform granulation and a granulating method of a fluidized-bed/spouted-bed type for forming a fluidized bed and a spouted bed to perform granulation are preferable in terms of uniformity of a coating state and uniformity of drying, and in particular, a granulating method of a fluidized-bed/spouted-bed type is more preferable. However, the granulating method is not limited thereto, and other methods can also be used. Examples of other methods include, for example, a granulating method of a tumbling granulation type or an agitation granulation type.

When granulation of a fluidized-bed type or a fluidized-bed/spouted-bed type is performed in the granulating step (gr), a heated fluidization gas is supplied to the seed particles from below to form a fluidized bed of the seed particles. “Fluidized bed” means a bed-form space containing floating and fluidizing seed particles. “Fluidization gas” means a gas supplied almost equally to the seed particles from below via a member such as a perforated plate or the like to form such a fluidized bed.

Further, “seed particles” in the granulating step (gr) mean encompassing not only seed particles before granulation (seed particles at the time of supplying and coated with nothing), but also seed particles during granulation (seed particles coated with the coating substance to a certain degree).

When granulation of a fluidized-bed type is performed, the solution containing the coating substance is sprayed to the seed particles in the fluidized bed to coat the surface of the seed particles with the coating substance. This solution containing the coating substance may be sprayed from a portion different from a fluidization gas supplying portion or may be sprayed together with the fluidization gas. In particular, the solution is preferably sprayed together with the fluidization gas.

On the other hand, when granulation of a fluidized-bed/spouted-bed type is performed, a heated spouting gas is spurted to the seed particles from below to form not only the fluidized bed but also a spouted bed. “Spouted bed” means a protruding space containing floating and vertically fluidizing seed particles. “Spouting gas” means a gas partially spurted to the seed particles from below to form such a spouted bed. When granulation of a fluidized-bed/spouted-bed type is performed, the solution containing the coating substance is preferably sprayed together with the spouting gas.

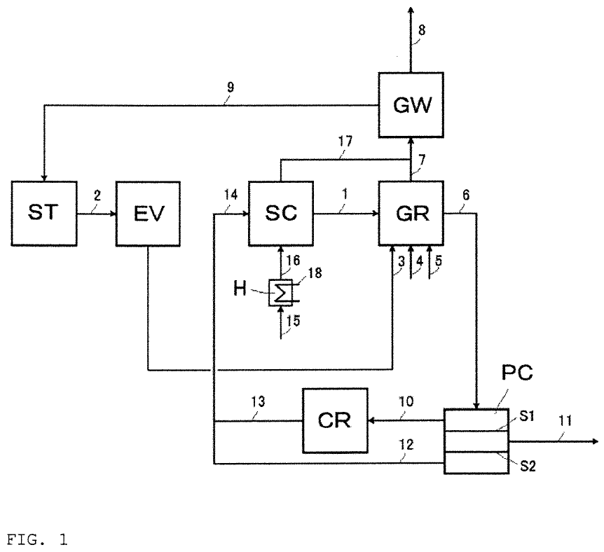

In the granulating step (gr), performing granulation under the high-temperature atmosphere allows conditioning of a coating state and a drying state. “Performing granulation under the high-temperature atmosphere” means performing granulation under a gas having a temperature higher than normal temperature (ambient temperature). For example, in the embodiment shown in FIG. 1, at least a gas in a zone in which granulation is performed within the granulating device (GR) has a temperature higher than ambient temperature. A particle temperature also reaches a temperature almost the same as in this atmosphere. A gas that forms this atmosphere is typically air. However, the present invention is not limited thereto, and a gas other than air such as nitrogen or the like can also be used.

The gas that forms the above atmosphere in the granulating step (gr) is, for example, a gas containing the gas supplied to form the fluidized bed when granulation of a fluidized-bed type is performed, or a gas containing the gas supplied to form the fluidized bed and the gas supplied to form the spouted bed when granulation of a fluidized-bed/spouted-bed type is performed. For example, the gases supplied for such purposes can be moderately heated in advance and then supplied to condition a temperature of the gas in the zone in which granulation is performed. A specific temperature of the atmosphere under which granulation is performed is not particularly limited, and may be appropriately determined according to the type of a target granular product. However, 80 °C to 140 °C is preferable. For example, when particles such as urea particles or the like are produced, 95 °C to 120 °C is more preferable and 110 °C to 120 °C is particularly preferable. Further, for example, when particles such as urea particles or the like are produced, the solution containing the coating substance preferably has a temperature of 125 °C to 145 °C.

Supplying or spurting pressure, supplying or spurting rate and supplying or spurting flow rate of the fluidization gas and the spouting gas may be appropriately conditioned such that the fluidized bed and the spouted bed can be suitably formed according to various conditions such as particle sizes, weights and amounts or the like of the seed particles used and particles after granulation. Further, a spraying pressure, spraying rate and spraying flow rate of the solution containing the coating substance may also be appropriately conditioned according to the above various conditions of the seed particles used and the particles after granulation.

In the solution containing the coating substance used in the granulating step (gr), a concentration of the coating substance may be appropriately conditioned such that a good coating state is attained. Further, before use of this solution in the granulating step (gr), a liquid in the solution may be partially evaporated in an evaporating step (ev) to increase a concentration of the coating substance. A concentration of the coating substance in the solution used in the granulating step (gr) may be appropriately conditioned according to various conditions such as the types of materials and particle sizes or the like of the seed particles used and the particles after granulation. For example, when particles such as urea particles or the like are produced, a concentration of the coating substance in the solution is preferably 94 mass % to 98.5 mass %. A solvent is preferably water. However, the present invention is not limited thereto.

The particles obtained in the granulating step (gr) have an average particle size of preferably 0.4 mm to 10 mm and more preferably 1 mm to 6 mm. This average particle size is a value measured by a sieving test method in conformance with JIS Z 8815. For example, the particles having such an average particle size can be classified to obtain product size particles (particles having a target particle size).

The particles obtained in the granulating step (gr) have a moisture content of preferably 0.5 mass % or less and more preferably 0.2 mass % or less. This moisture content is a value measured by Karl Fischer titration method. The particles having such a low moisture content are excellent in handleability.

The particles obtained in the granulating step (gr) are preferably classified in a particle classifying step (pc) to collect the product size particles (particles having a target particle size). The particle classifying step (pc) is described later in detail.

In a gas discharged from the granulating step (gr), a small amount of dust is entrained in usual. The dust-containing gas discharged in the granulating step (gr) is, for example, washed in a gas washing step (gw) to remove dust, and the gas after washing is exhausted and on the other hand, the removed dust is preferably returned to the solution containing the coating substance (for example, the solution in a solution tank) and recycled.

FIG. 1 is a process flow diagram illustrating an embodiment of the method and apparatus of the present invention.

In FIG. 1, the seed particles heated by the seed particle conditioning device (SC) are supplied to the granulating device (GR) of a fluidized-bed/spouted-bed type via a line 1. Further, a solution from the solution tank (ST) (the solution containing the coating substance) is supplied to the granulating device (GR) via a line 2, an evaporating unit (EV) and a line 3. In this evaporating unit (EV), a liquid in the solution is partially evaporated to increase a concentration of the coating substance. Further, the spouting gas is supplied to the granulating device (GR) from a line 4 and the fluidization gas is supplied to the granulating device (GR) from a line 5, thereby forming the fluidized bed and the spouted bed. Further, within the granulating device (GR), the solution containing the coating substance is sprayed together with the spouting gas to coat the surface of the seed particles with the coating substance to carry out granulation. The particles after granulation are supplied to a particle classifying device (PC) via a line 6.

In FIG. 1, the dust-containing gas discharged from the granulating device (GR) is supplied to the gas washing device (GW) provided with a device such as a scrubber or the like via a line 7. In this gas washing device (GW), the gas is washed to remove dust, and the gas after washing is exhausted from a line 8. Further, the removed dust is dissolved in a solvent, then supplied as a solution to the solution tank (ST) via a line 9 and recycled.

### Particle Classifying Step (PC) and Crushing Step (CR)

The method of the present invention preferably includes the particle classifying step (pc) for classifying the particles granulated in the granulating step (gr) to collect the product size particles (particles having a target particle size) obtained through this classification. Further, particles below the product size obtained through this classification are preferably recycled as the seed particles. Further, the method of the present invention preferably also includes a crushing step (cr) for crushing large particles above the product size obtained through the classification in the particle classifying step (pc) to recycle the particles crushed into a smaller size through this crushing as the seed particles.

The apparatus of the present invention preferably includes the particle classifying device (PC) for classifying the particles granulated in the granulating device (GR) to collect the product size particles obtained through this classification. Further, the particles below the product size obtained through this classification are preferably recycled as the seed particles. Further, the apparatus of the present invention preferably also includes a crushing device (CR) for crushing the large particles above the product size obtained through the classification in the particle classifying device (PC) to recycle the particles crushed into a smaller size through this crushing as the seed particles.

In each explanation above, “recycling as the seed particles” specifically means using them as the seed particles in the seed particle conditioning or granulation.

A possible classifying method in the particle classifying step (pc) is, for example, a method for classifying, by using a screen or a sieve, the particles granulated in the granulating step (gr) into the product size particles, the large particles above the product size and the small particles below the product size. However, the present invention is not limited thereto.

In FIG. 1, the particles granulated in the granulating device (GR) are supplied to the particle classifying device (PC) via the line 6. Two screens (S1) and (S2) are provided inside the particle classifying device (PC). First, the large particles above the product size do not pass through the screen (S1), and particles other than those pass therethrough. Next, the product size particles do not pass through the screen (S2), and the small particles below the product size pass therethrough. Further, the particles above the product size are supplied to the crushing device (CR) via a line 10. The product size particles are collected via a line 11. The particles below the product size are supplied to the seed particle conditioning device (SC) via lines 12 and 14. Further, the particles after crushing into a desired particle size in the crushing device (CR) are supplied to the seed particle conditioning device (SC) via lines 13 and 14.

### Seed Particle Conditioning Step (SC)

In the present invention, the seed particle conditioning step (sc) is a step of supplying a preheating gas to the seed particles from below to form a fluidized bed of the seed particles and preheat the seed particles in the fluidized bed. Further, the seed particle conditioning device (SC) is a device for supplying a preheating gas to the seed particles from below to form a fluidized bed of the seed particles and preheat the seed particles in the fluidized bed.

As the seed particles preheated in the seed particle conditioning step (sc), for example, the particles below the product size obtained through the classification in the particle classifying step (pc) described above, and the particles obtained by crushing, in the crushing step (cr), the particles above the product size obtained through the classification in the particle classifying step (pc) described above can be used. However, the present invention is not limited thereto. Particles not undergoing the particle classifying step (pc), for example, seed particles prepared in advance, such as nuclei supplied to a granulator in JP-A H11-137988, can also be used.

The seed particles preheated in the seed particle conditioning step (sc) have an average particle size of preferably 0.4 mm to 3 mm and more preferably 1 mm to 2 mm. This average particle size is a value measured by the method described earlier.

In the seed particle conditioning step (sc), the preheating gas is supplied to the seed particles from below to form the fluidized bed of the seed particles. In other words, the preheating gas functions also as a fluidization gas. This preheating gas is typically air. However, the present invention is not limited thereto, and a gas other than air such as nitrogen or the like can also be used.

The preheating gas in the seed particle conditioning step (sc) has a temperature of preferably 80 °C to 140 °C and more preferably 90 °C to 120 °C. This preheating gas is a preheating means for suppressing deterioration in uniformity of a temperature within the granulating device (GR) (particularly, near a seed particle supply inlet) and uniformity of drying. Therefore, a temperature of the preheating gas is preferably the same as or approximates a temperature of the atmosphere in the granulating step (gr) described earlier.

A supplying pressure, a supplying rate and a supplying flow rate of the preheating gas in the seed particle conditioning step (sc) may be appropriately conditioned such that the fluidized bed can be suitably formed according to various conditions such as a particle size, a weight and an amount or the like of the seed particles used.

As explained above, in the present invention, deterioration in uniformity of a temperature within the granulating device (GR) and uniformity of drying can be suppressed as the seed particles before use in the granulating step (gr) are preheated in advance in the seed particle conditioning step (sc). Further, in terms of easiness of continuous steps and temperature stability, the seed particles heated in the seed particle conditioning step (sc) are preferably supplied to the granulating step (gr) in such a manner that the particles are sent by gravity flow via a direct device connection.

In FIG. 1, the particles after crushing from the crushing device (CR) and the particles below the product size from the particle classifying device (PC) are supplied to the seed particle conditioning device (SC) via the lines 13 and 14 and via the lines 12 and 14, respectively, and used as the seed particles.

In FIG. 1, a gas is supplied to a heating device (H) via a line 15, and a temperature of the gas is increased by heat of steam flowing within internal piping 18 of the heating device (H). Further, the gas heated by this heating device (H) is supplied as the preheating gas to the seed particle conditioning device (SC) via a line 16. This preheating gas is supplied to the seed particles from below to form the fluidized bed of the seed particles and preheat the seed particles in the fluidized bed. The seed particles after preheating are supplied to the granulating device (GR) via the line 1.

In FIG. 1, a dust-containing gas is discharged from an upper portion of the seed particle conditioning device (SC), and supplied to the gas washing device (GW) provided with a device such as a scrubber or the like via a line 17. As explained earlier, in this gas washing device (GW), the gas is washed to remove dust, and the gas after washing is exhausted from the line 8. Further, the removed dust is dissolved in a solvent to be in the state of a solution, then supplied to the solution tank (ST) via the line 9 and recycled.

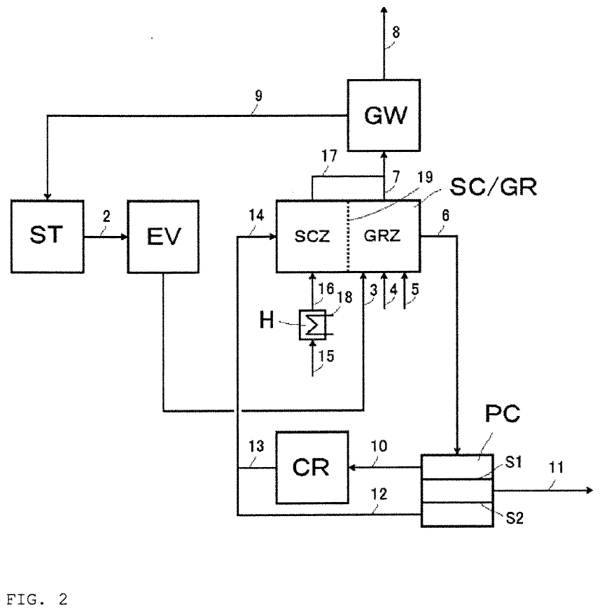

The above explanation describes the case where the seed particle conditioning device (SC) and the granulating device (GR) are separate devices, as illustrated in FIG. 1. However, the present invention is not limited thereto. For example, as illustrated in FIG. 2, a single device including a seed particle conditioning zone (SCZ) and a granulating zone (GRZ), in other words, a seed particle conditioning and granulating device (SC/GR) may also be used.

In FIG. 2, the seed particle conditioning zone (SCZ) and the granulating zone (GRZ) partitioned by a partition wall 19 within the seed particle conditioning and granulating device (SC/GR) have the same functions as the seed particle conditioning device (SC) and the granulating device (GR) explained earlier, respectively. Particles preheated in the seed particle conditioning zone (SCZ) are supplied to the granulating zone (GRZ) by gravity-flow falling. Note that the seed particle conditioning zone (SCZ) within the seed particle conditioning and granulating device (SC/GR) is preferably located upper than the granulating zone (GRZ) when the particles are supplied to the granulating zone (GRZ) by gravity-flow falling, although FIG. 2 describes both zones parallel to each other for convenience of a comparison with FIG. 1.

### Method for Improving Existing Particle Processing Apparatus

The processing apparatus of the present invention may be implemented by making an improvement to an existing particle processing apparatus.

For example, the particle processing apparatus of the present invention (see FIG. 1) can be implemented by making an improvement of adding the seed particle conditioning device (SC) to an existing particle processing apparatus with the granulating device (GR). In this case, seed particles after heating by the seed particle conditioning device (SC) are coated with a coating substance under a high-temperature atmosphere to carry out granulation in the granulating device (GR). Further, for example, the particle processing apparatus of the present invention (see FIG. 2) can be implemented by making an improvement of replacing the granulating device (GR) in the existing particle processing apparatus with the seed particle conditioning and granulating device (SC/GR). In this case, seed particles after heating in the seed particle conditioning zone (SCZ) are coated with a coating substance under a high-temperature atmosphere to carry out granulation in the granulating zone (GRZ).

### Granular Product

The particles obtained by the present invention are useful as various granular products such as, for example, chemical products, medicines, food and others. In particular, the present invention is preferably applied to production of a granular product for which granulation using seed particles is industrially performed. Preferable specific examples of such a granular product include, in particular, urea particles.

However, the present invention is not limited thereto. The present invention can be applied also to production of a granular product other than urea particles such as, for example, ammonium nitrate particles, ammonium sulfate particles or the like.

When urea particles are obtained by the present invention, seed particles are urea particles, and a solution containing a coating substance is an aqueous urea solution. Urea particles as a granular product have an average particle size of preferably 1 mm to 5 mm and more preferably 2 mm to 4 mm. The urea particles have a moisture content of preferably 0.5 mass % or less and more preferably 0.2 mass % or less. These average particle size and moisture content are values measured by the methods described earlier. The urea particles with such average particle size and moisture content are useful for applications such as a fertilizer and others.

In the present invention, the seed particles and the coating substance are preferably the same material like the urea particles explained above. However, the present invention is not limited thereto. Different materials can also be used for the seed particles and the coating substance depending on the type of a target granular product.

### INDUSTRIAL APPLICABILITY

The present invention is useful as particle processing method and processing apparatus allowing stable granulation into particles that are uniformly dried to a desired level and have a desired particle size.

### DESCRIPTION OF THE REFERENCE NUMERALS

SC Seed particle conditioning device
GR Granulating device
ST Solution tank
EV Evaporating unit
GW Gas washing device
PC Particle classifying device
S1, S2 Screen
CR Crushing device
H Heating device
1 Line (seed particles)
2 Line (solution)
3 Line (solution)
4 Line (spouting gas)
5 Line (fluidization gas)
6 Line (particles)
7 Line (discharged gas)
8 Line (gas after washing)
9 Line (solution in which dust is dissolved)
10 Line (particles above product size)
11 Line (product size particles)
12 Line (particles below product size)
13 Line (particles after crushing)
14 Line (particles below product size and particles after crushing)
15 Line (gas)
16 Line (preheating gas)
17 Line (dust-containing gas)
18 Internal piping (steam)
19 Partition wall

1. A particle processing method comprising:
a seed particle conditioning step (sc) of supplying a preheating gas to seed particles from below to form a fluidized bed of the seed particles and preheat the seed particles in the fluidized bed; and
a granulating step (gr) of coating a surface of the seed particles heated in the seed particle conditioning step (sc) with a coating substance under a high-temperature atmosphere to carry out granulation,
wherein the seed particles are urea particles, the coating substance is urea, the preheating gas has a temperature of 80 °C to 140 °C, and a gas that forms the high-temperature atmosphere in the granulating step (gr) has a temperature of 80 °C to 140 °C.

2. The particle processing method according to claim 1, wherein the preheating gas has the same temperature as a temperature of the atmosphere in the granulating step (gr).

3. The particle processing method according to claim 1, wherein the preheating gas has a temperature of 90 °C to 120 °C, and the gas that forms the high-temperature atmosphere in the granulating step (gr) has a temperature of 95 °C to 120 °C.

4. A particle processing apparatus comprising:
a seed particle conditioning device (SC) for supplying a preheating gas to seed particles from below to form a fluidized bed of the seed particles and preheat the seed particles in the fluidized bed; and
a granulating device (GR) for coating a surface of the seed particles heated by the seed particle conditioning device (SC) with a coating substance under a high-temperature atmosphere to carry out granulation,
wherein the seed particles are urea particles, the coating substance is urea, the preheating gas has a temperature of 80 °C to 140 °C, and a gas that forms the high-temperature atmosphere in the granulating device (GR) has a temperature of 80 °C to 140 °C.

5. A particle processing apparatus with a seed particle conditioning and granulating device (SC/GR) comprising:
a seed particle conditioning zone (SCZ) in which a preheating gas is supplied to seed particles from below to form a fluidized bed of the seed particles and preheat the seed particles in the fluidized bed; and
a granulating zone (GRZ) in which a surface of the seed particles heated in the seed particle conditioning zone (SCZ) is coated with a coating substance under a high-temperature atmosphere to carry out granulation,
wherein the seed particles are urea particles, the coating substance is urea, the preheating gas has a temperature of 80 °C to 140 °C, and a gas that forms the high-temperature atmosphere in the granulating zone (GRZ) has a temperature of 80 °C to 140 °C.

6. A method for improving an existing particle processing apparatus with a granulating device (GR) for coating a surface of seed particles with a coating substance under a high-temperature atmosphere to carry out granulation, comprising:
adding, to the existing particle processing apparatus, a seed particle conditioning device (SC) for supplying a preheating gas to seed particles from below to form a fluidized bed of the seed particles and preheat the seed particles in the fluidized bed, such that the seed particles after heating by the seed particle conditioning device (SC) are coated with the coating substance under the high-temperature atmosphere to carry out granulation in the granulating device (GR); or
replacing the granulating device (GR) with a seed particle conditioning and granulating device (SC/GR) including a seed particle conditioning zone (SCZ) in which a preheating gas is supplied to seed particles from below to form a fluidized bed of the seed particles and preheat the seed particles in the fluidized bed and a granulating zone (GRZ) in which a surface of the seed particles heated in the seed particle conditioning zone (SCZ) is coated with a coating substance under a high-temperature atmosphere to carry out granulation, such that the seed particles after heating in the seed particle conditioning zone (SCZ) are coated with the coating substance under the high-temperature atmosphere to carry out granulation in the granulating zone (GRZ),
wherein the seed particles are urea particles, the coating substance is urea, the preheating gas has a temperature of 80 °C to 140 °C, and a gas that forms the high-temperature atmosphere has a temperature of 80 °C to 140 °C.
